(19) United States
(12) Patent Application Publication
(10) Pub. No.: US 2005/0254390 A1
(43) Pub. Date: Nov. 17, 2005

(54) Data decoding apparatus and method, charge information processing apparatus and method, data reproducing apparatus and method, electronic money, electronic use right, and terminal apparatus

(75) Inventors: Tatsuya Inokuchi, Kanagawa (JP); Yoichiro Sako, Tokyo (JP)

Correspondence Address: Jay H. Maioli;Cooper & Dunham, 1185 Avenue of the Americas, New York, NY, 10036, US

(73) Assignee: Sony Corporation

(21) Appl. No.: 11/185,254

(22) Filed: Jul. 20, 2005

Related U.S. Application Data
(63) Continuation of application No. 09/869,816, filed on Jul. 3, 2001.

(30) Foreign Application Priority Data
Nov. 5, 1999 (JP) 314880/1999
Nov. 24, 1999 (JP) 332628/1999

(51) Int. Cl. G11B 5/09

(52) U.S. Cl. 369/59.23; 369/59.1; 369/47.1

(57) ABSTRACT

Reproduction data is supplied to a decoder and encryption is decoded. A reproducing conditions label is detected by a reproducing conditions label detecting unit. Compression encoding is decoded by a decompressor. A watermark detecting unit discriminates whether the reproducing conditions label has been falsified or not. In a listening right counter, each time the reproduction data is decoded, listening right data is changed. The listening right data transmitted from a prepaid data charger by an antenna and a communicating module is stored into a memory unit. An encrypting module and a decoding module are provided in the communicating module. In a water mark adding unit, a watermark is added to output data. The data is converted into an analog output by a D/A converter and outputted to the outside.

### TECHNICAL FIELD

The invention relates to data decoding apparatus and method, charge information processing apparatus and method, data reproducing apparatus and method, electronic money, an electronic use right, and a terminal apparatus which are applied to, for example, music distribution.

### BACKGROUND ART

In a Compact Disc (CD), DVD (Digital Versatile Disc or Digital Video Disc), or the like, various copy preventing techniques for preventing an illegal copy have been proposed and put into practical use for the purpose of protecting a copyright. For example, the SCMS (Serial Copy Management System) is a technique such that although a copy of the first generation from the CD to a recordable optical disc is permitted, a copy from the recordable optical disc to another recording medium or memory medium is inhibited. A copy generation limiting system for limiting the generation of the copy which can be formed is also known.

In recent years, under the rapid development of a network such as Internet, music contents is distributed through the network. In such a situation, EMD (Electronic Music Distribution) using the network such as Internet, satellite broadcast, or the like has been started and a method of copyright management in the EMD has also been proposed. In the EMD, the user can obtain music contents by being charged. Also in the EMD, the technique such as SCMS, copy generation limitation, or the like as mentioned above is being used for preventing the illegal copy.

As mentioned above, since the conventional copyright protecting method is a method of limiting the copy by using the copy preventing technique and protecting the right of the copyrighter, it becomes an obstacle when the music contents is widely circulated in a short time. For example, there is an assessment system as one of the conventional copyright protecting systems. Such a system has been enforced in a DAT (Digital Audio Taperecorder) or the like, and the user of a digital recording apparatus pays compensation added to a product price. Now that the network has been developed, in many cases, hardware (player, media) and the contents do not correspond in a one-to-one relational manner as seen in an example such that the contents distributed through the network is received and reproduced by a PC (personal computer). Such an assessment system is improper as a system for protection of the copyright.

When a plurality of music pieces have been recorded in a media, for example, a CD, there is a case where the user wants to listen only to a specific one or a few music pieces among the music pieces recorded in the CD or a case where he does not want to purchase the whole media. Further, the contents cannot be freely distributed or circulated and advertisement and circulation of the music contents are obstructed because of the foregoing copy preventing techniques. Rather, if the music contents is distributed free of charge, the advertisement and circulation of the music contents can be performed in a short time and the costs for the advertisement and circulation can be also cut.

In consideration of such problems, a distribution system such that the distribution of contents data is free and when it is reproduced, it is charged for is preferable. In such a system, various processes can exist as reproduction charging processes. Hitherto, a method of performing the charging process in accordance with various kinds of reproduction charges is not used. It is necessary that listening right data for causing a listening right can be safely handed to the user.

In consideration of the above problems, therefore, it is an object of the invention to provide data decoding apparatus and method, charge information processing apparatus and method, data reproducing apparatus and method, electronic money, an electronic use right, and a terminal apparatus which can manage a reproduction charging system.

### DISCLOSURE OF INVENTION

To solve the above problems, according to the invention of Claim 1, there is provided a data decoding apparatus comprising: decoding means for decoding encoded or encrypted digital data; memory means for storing monitoring right data; and charge control means for, when the encoded or encrypted data is decoded, changing the monitoring right data in the memory means in accordance with an instruction of reproducing conditions information associated with the digital data, thereby performing a charging process.

According to the invention of Claim 11, there is provided a data decoding method comprising the steps of: decoding encoded or encrypted digital data; and when the encoded or encrypted data is decoded, changing stored monitoring right data in accordance with an instruction of reproducing conditions information associated with the digital data, thereby performing a charging process.

According to the invention of Claim 12, there is provided a charge information processing apparatus for relaying monitoring right data between a settlement center and a data decoding apparatus, wherein the apparatus is constructed as a portable type so that it can be shared among a plurality of data decoding apparatuses.

According to the invention of Claim 18, there is provided a charge information processing apparatus for relaying monitoring right data between a settlement center and a data decoding apparatus, comprising: communicating means which can be directly connected to the settlement center through wire or radio communicating means or can be connected thereto by relaying another apparatus; means for safely obtaining the monitoring right data from the settlement center; memory means for storing the monitoring right data; and an interface having means for safely transferring a part or all of the monitoring right data to/from an external apparatus.

According to the invention of Claim 24, there is provided a charge information processing apparatus for relaying monitoring right data between a settlement center and a data decoding apparatus, comprising.: an interface having means for safely transferring a part or all of the monitoring right data to/from an external apparatus; and memory means for storing the monitoring right data, wherein the interface can transfer the monitoring right data to/from an IC card.

According to the invention of Claim 28, there is provided a charge information processing method of relaying monitoring right data between a settlement center and a data decoding apparatus, comprising the steps of: directly connecting to the settlement center through wire or radio communicating means or connecting thereto by relaying another apparatus; safely obtaining the monitoring right data from the settlement center; storing the monitoring right data; and safely transferring a part or all of the monitoring right data to/from an external apparatus.

According to the invention of Claim 29, there is provided a data reproducing apparatus for reproducing compression encoded and/or encrypted digital data, comprising a decoding apparatus for decoding the digital data, wherein
the decoding apparatus has: decoding means for decoding the encoded or encrypted digital data; memory means for storing monitoring right data; and charge control means for, when the encoded or encrypted data is decoded, changing the monitoring right data in the memory means in accordance with an instruction of reproducing conditions information associated with the digital data, thereby performing a charging process.

According to the invention of Claim 30, there is provided a data reproducing method of reproducing compression encoded and/or encrypted digital data, comprising the steps of: decoding the encoded or encrypted digital data; and when the encoded or encrypted digital data is decoded, changing stored monitoring right data in accordance with an instruction of reproducing conditions information associated with the digital data, thereby performing a charging process.

According to the invention of Claim 31, there is provided a charge information processing apparatus in which compression encoded and/or encrypted software is distributed free of charge and a charging process is performed when the distributed software is decoded, comprising: means which can be connected to a user terminal in which past use history information of software in a user device has been stored through wire or radio communicating means; and authentication/encrypting means for safely transmitting and receiving use right data to/from the user terminal, wherein when the use right data is sold to the user terminal, the use history information is transferred from the user terminal.

According to the invention of Claim 39, there is provided a charge information processing method in which compression encoded and/or encrypted software is distributed free of charge and a charging process is performed when the distributed software is decoded, comprising the steps of: connecting to a user terminal in which past use history information of software in a user device has been stored through wire or radio communicating means; performing authentication/encryption for safely transmitting or receiving use right data to/from the user terminal; and when the use right data is sold to the user terminal, transferring the use history information from the user terminal.

According to the invention of Claim 40, there is provided electronic money having an effect corresponding to cash, wherein its use period is limited.

According to the invention of Claim 41, there is provided an electronic use right for enabling the use of software such as reproduction of contents or the like, wherein its use period is limited.

According to the invention of Claim 42, there is provided a system in which electronic money or an electronic use right whose use period is limited and electronic money or an electronic use right whose use period is not limited exist mixedly.

According to the invention of Claim 49, there is provided a decoding apparatus comprising: a decoding unit for performing a decoding process to compressed and/or encrypted data which was read out from a medium and includes data regarding reproducing conditions; a storing unit for storing monitoring right data; and a control unit for, when the read-out data is decoded by the decoding unit in the case where the read-out data is data as a target of charging, performing a changing process to the monitoring right data stored in the storing unit on the basis of the data regarding the reproducing conditions separated by the decoding unit.

According to the invention of Claim 64, there is provided a reproducing apparatus comprising: a decoding unit for performing a decoding process to compressed and/or encrypted data which was read out from a medium and includes data regarding reproducing conditions; a storing unit for storing monitoring right data; a control unit for, when the read-out data is decoded by the decoding unit in the case where the read-out data is data as a target of charging, performing a changing process to the monitoring right data stored in the storing unit on the basis of the data regarding the reproducing conditions separated by the decoding unit; an operation unit which is operated by the user; and a system control unit for supplying a control signal to the control unit on the basis of an input from the operation unit.

According to the invention of Claim 81, there is provided a terminal apparatus comprising: a first transmitting and receiving unit for transmitting and receiving at least monitoring right data to/from a communicating unit of a reproducing apparatus having a decoding unit for performing a decoding process to compressed and/or encrypted data which was read out from a medium and includes data regarding reproducing conditions, a storing unit for storing the monitoring right data and data regarding a reproduction history, a control unit for, when the read-out data is decoded by the decoding unit in the case where the read-out data is data as a target of charging, performing a changing process to the monitoring right data stored in the storing unit on the basis of the data regarding the reproducing conditions separated by the decoding unit, and the communicating unit; a second transmitting and receiving unit for transmitting and receiving at least the monitoring right data to/from an outside; and a data holding unit for holding a monitoring right obtained from the outside through the second transmitting and receiving unit and holding individual identification data.

### BRIEF DESCRIPTION OF DRAWINGS

FIG. 1 is a block diagram showing an outline of a whole system according to an embodiment of the invention.

FIG. 2 is a block diagram for explanation regarding listening right data in the embodiment of the invention.

FIG. 3 is a block diagram for explanation regarding the listening right data in the embodiment of the invention.

FIG. 4 is a block diagram for explanation regarding functions which are performed by a settlement center in the embodiment of the invention.

FIG. 5 is a block diagram of an example of a player in the embodiment of the invention.

FIG. 6 is a flowchart for explaining an example of a charging process in the embodiment of the invention.

FIG. 7 is a block diagram of an example of a listening right data charger in the embodiment of the invention.

FIG. 8 is a more detailed block diagram of a secure decoder in the embodiment of the invention.

FIG. 9 is a block diagram showing a construction of a portion regarding a charging process of the secure decoder.

FIG. 10 is a flowchart for explaining a process for detecting a watermark in the secure decoder.

FIG. 11 is a flowchart for explaining a process for adding the watermark in the secure decoder.

FIG. 12 is a block diagram for use in explanation of the data charger in the invention.

FIGS. 13A and 13B are schematic diagrams of an example of a data construction of the listening right data in the invention.

FIG. 14 is a flowchart for explaining an example of services which are provided in the invention.

FIG. 15 is a flowchart for explaining another example of services which are provided in the invention.

### BEST MODE FOR CARRYING OUT THE INVENTION

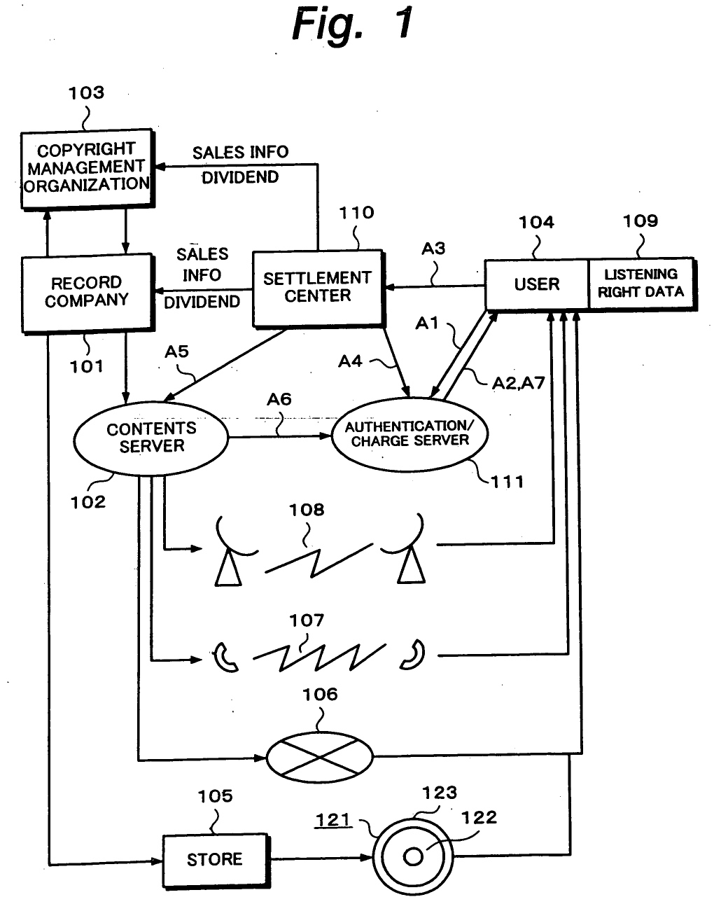

An embodiment in which the invention is applied to a music distribution system will be described herein below. An outline of the music distribution system will be first described with reference to FIG. 1. In FIG. 1, reference numeral 101 denotes a music contents supply provider, for example, a record company and 102 indicates a contents server. The record company 101 produces music contents and distributes them. The record company 101 also performs compression encoding and encryption of the music contents and embedding of a watermark into the music contents. Contents data produced by the record company 101 is accumulated into the contents server 102.

Reference numeral 103 denotes a copyright management organization. For example, the JASRAC (Japanese Society of Rights of Authors and Composers) is a specific example of the copyright management organization 102. The record company 101 receives permission of a copy or the like from the copyright management organization 103 and pays a copyright fee to the copyright management organization 103.

Reference numeral 104 denotes a user device having a reproducing function of the distributed music contents. The user device 104 has a function for reproducing the contents data including the distributed music contents and executing a reproduction charging process. That is, the user device 104 decodes the encryption of the distributed contents data and decodes the compression encoding, so that it can reproduce the music contents. The decoding of the contents data including the music contents is charged for. A contents distribution provider exists between the contents server 102 and user device 104 as necessary and distributes the contents data in the contents server 102 to the user. There are several means as distributing means which is used by the distribution provider. One of the means is a store 105. For example, a media in which the contents data has been recorded is distributed as a supplement of a magazine. A wire network 106 such as Internet or a CATV (cable television) is used as distributing means of the contents data. Further, a cellular phone network 107 and a satellite network 108 such as satellite broadcast, satellite communication, or the like are used as distributing means of the contents data.

In the invention, the use of the distributing means of the contents which is distributed with charge as contents distributing means is not obstructed. In case of a medium, for example, a CD, a copyright fee for the recorded music pieces is included in the price of the CD. The contents data whose distribution is made free and whose decoding (reproduction) is charged for can be also recorded into an area different from an area on the CD where the toll contents data has been recorded.

In FIG. 1, an extended CD 121 is shown as one of media which are distributed by the store 105. An area 122 on the inner rim side of the extended CD 121 is an area where the music piece data whose distribution is charged for and whose reproduction is made free has been recorded in the same format as that of the existing CD. An area 123 on the outer rim side of the extended CD 121 is an area where the contents data whose distribution is made free and whose reproduction is charged for has been recorded. Since the contents data recorded in the area 123 on the outer rim side has been compression encoded, even if the area 123 on the outer rim side is small, for example, music data of the same length as that of the music piece data recorded in the area 122 on the inner rim side can be recorded.

Even in case of a medium such as recordable small optical disc which is called MD (Mini Disc), memory card, or the like other than the CD, the contents whose distribution is charged for and whose reproduction is made free and the contents data whose distribution is made free and whose reproduction is charged for can be recorded in the respective areas which can be distinguished from each other. The contents data whose distribution is made free and whose reproduction is charged for can be also distributed by using a service for distributing the music contents data by using the satellite television broadcast.

The user device 104 can receive the contents data free of charge as mentioned above. The received contents data can be also freely redistributed. “free of charge” here denotes that the actual costs such as communication fee, electricity, and the like are not included and the copyright fee is free. When the user device 104 reproduces the received contents data, more specifically, decodes the encryption of the contents data, the charging process is performed. Listening right data 109 isused for the charging process. The listening right data 109 has been stored in the prepaid card or a memory in the secure decoder. The listening right data 109 can be rewritten by a charging charger which the user possesses or by a store terminal installed in the nearest store under the management of the listening right data management company. The listening right data 109 is, for example, a reproducible degree and the degree is subtracted each time the user device 104 reproduces the contents data as a target of charging.

A settlement center 110 exists for settlement of costs in conjunction with the record company 101, copyright management organization 103, and user device 104. The settlement center 110 has an authentication/charge server 111. The settlement center 110 performs the settlement of the costs with a bank/credit card company (not shown).

When the user device 104 requests the listening right data in order to reproduce the received contents data, the authentication/charge server 111 is requested to authenticate the user device 104 (shown by a path A1 in FIG. 1). When the user device 104 is legal and the authentication is satisfied, the authentication/charge server 111 requests the charge from the user device 104 (path A2 in FIG. 1). The user device 104 performs the costs settlement with the settlement center 110 (path A3 in FIG. 1).

As shown by a path A4 in FIG. 1, the settlement center 110 transfers information showing that the charge has been performed or the charge is possible to the authentication/charge server 111 and requests key data information of the contents from the contents server 102 (path A5 in FIG. 1). The contents server 102 hands key data serving as a master for decoding the encryption to the authentication/charge server 111 (path A6 in FIG. 1). The authentication/charge server 111 hands the key data to the user device 104 together with listening right data (path A7 in FIG. 1). The user device 104 can decode the encryption of the contents data by the key data transmitted from the server 111 and reproduce the contents data. When the contents data is decoded, it is determined that the contents data has been reproduced, and the degree of the listening right data 109 is subtracted by “1”. When the degree of the data 109 reaches “0”, the user device 109 cannot decode the contents data. Although the case where the key data serving as a master is transmitted together with the listening right data has been shown in FIG. 1, it is also possible to use a method whereby the fixed key data is preliminarily stored upon manufacturing of the user device, a method whereby the key data is embedded into the contents by encoding whose interpretation is difficult and the key data is transmitted together with the contents, or a method of a combination of those methods.

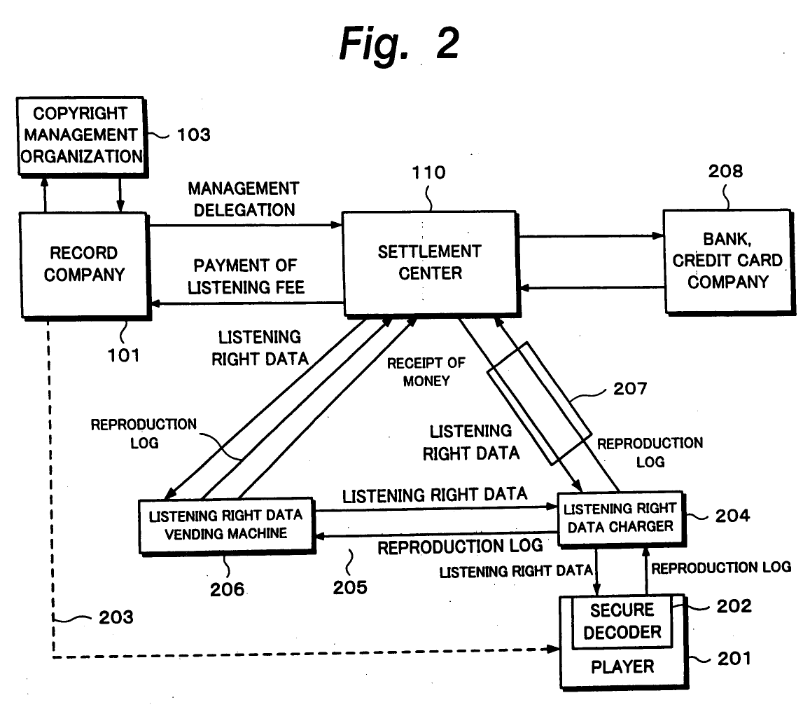

FIG. 2 shows an example of a system regarding the listening right data 109. The distribution of the music contents data and the transmission and reception of the data for decoding the encryption are omitted here. A player 201 is shown as a device corresponding to the user device 104. The player 201 has therein a secure decoder 202. The player 201 is, for example, a portable audio apparatus. In FIG. 2, as shown by a broken line the music contents data has been recorded in a storing or recording medium (optical disc, memory card, or the like) which is reproduced by the player 201. As a method of distributing the music contents data, various methods can be used as shown in FIG. 1.

Reference numeral 204 denotes a listening right data charger as a user terminal. The data charger 204 exists between the secure decoder 202 of the player 201 and the settlement center 110 or between the secure decoder 202 and a data sales terminal 206 installed in a record shop, a convenience store, or the like and functions as a listening right data relay. For example, when a plurality of user devices (CD player, MD player, audio apparatus which is mounted in a vehicle, etc. ) exist in a home, the data charger 204 is shared by the players 201 as a plurality of user devices. The data charger 204 is portable.

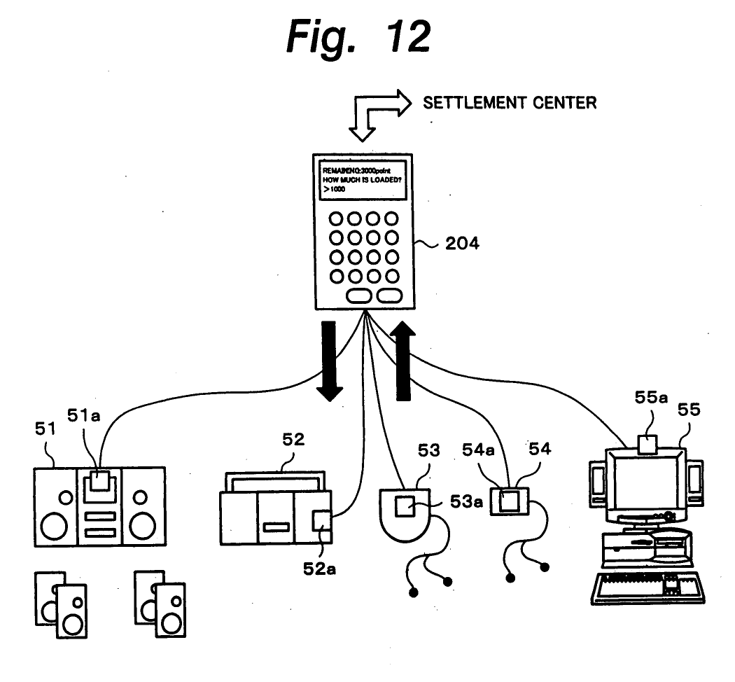

FIG. 12 schematically shows functions of the data charger 204. In FIG. 12, a specific example of the player 201 having a possibility of being installed in the home is shown. Reference numeral 51 denotes an audio reproducing system in which an amplifier and speakers are separately connected; 52 indicates a reproducing apparatus in which a tuner and a CD player (or MD (Mini Disc; trademark) recorder) are integratedly connected; 53 a portable CD player; 54 a portable MD player; and 55 a personal computer. Secure decoders 51a, 52a, 53a, 54a, and 55a each of which is constructed as an IC are built in the players as user devices. The data charger 204 is shared by those players and can transmit the listening right data and read out reproduction history information by a dedicated connecting line, contactless radio communication, USB (Universal Serial Bus), or IEEE (Institute of Electrical and Electronics Engineers) 1394.

The secure decoder 202 in the player 201 and the data charger 204 communicate through a wire or radio communication path. The listening right data is transferred from the data charger 204 to a memory in the secure decoder 202. The listening right data corresponds to, for example, information indicative of the number of reproduction possible times or a reproduction possible time of the player 201.

The reproduction history information (reproduction log) of the player 201 is transmitted from the player 201 to the data charger 204 through a wire or radio communication path 205. The reproduction log includes an identifier of the digital data as decoded contents data and/or decoding conditions. Specifically speaking, the reproduction log includes information such as kind of listened music contents, the number of reproducing times, and the reproducing time, and the like. Identifiers for specifying the person of a charge target such as owner of the player 201, identifier of the player 201, and the like are included in the reproduction log. The secure decoder 202 and data charger 204 authenticate each other. When the authentication is satisfied, the encrypted listening right data and the reproduction log are transmitted between the secure decoder 202 and data charger 204.

The listening right data is handed from the settlement center 110 to the data charger 204 through a communication path 207, for example, a telephone line, or the listening right data handed from the settlement center 110 to the sales terminal 206 through a communication path 209 is handed to the data charger 204 through the communication path 205. Also in this case, the authentication and encryption are performed in order to assure the security of the listening right data.

The reproduction log read out by the data charger 204 is sent to the settlement center 110 through the communication path 207. The read-out reproduction log is handed to the sales terminal 206 through the communication path 205. The sales terminal 206 receives the listening right data from the settlement center 110 through the communication path 209 and sends the reproduction log to the settlement center 110. Further, the sales terminal 206 pays the cost for the obtained listening right data to the settlement center 110. The communication path 209 is a telephone line, an Internet, or the like.

The listening right data and the reproduction log are transmitted and received between the settlement center 110 and listening right data charger 204 through the communication path 207. Also in this case, the authentication and the encryption are performed to the listening right data and the reproduction log in order to assure the security of the listening right data and the reproduction log. A bank/credit card company 208 exists with respect to the settlement of the listening right data. On the basis of a request from the settlement center 110, the bank/credit card company 208 withdraws a money amount corresponding to the listening right data written in the data charger 204 from a bank account of the user which has previously been registered.

Further, the settlement center 110 receives delegation of management of the services regarding the listening right data from the record company 101. The settlement center 110 provides a technique regarding the listening right data to the record company 101 and, further, pays a music piece listening fee. As described with reference to FIG. 1, the record company 101 pays the copyright fee in accordance with the use of the copyright to the copyright management organization 103.

Although not shown in FIG. 2, the listening right data charger 204 can perform a moving process, a summing process, or a dividing process to a part or all of the listening right data in conjunction with another charger through a communicating apparatus, for example, a contactless communicating apparatus. The data charger 204 can transfer the listening right data to a prepaid card having a construction of an IC card other than the secure decoder 202 of the player 201.

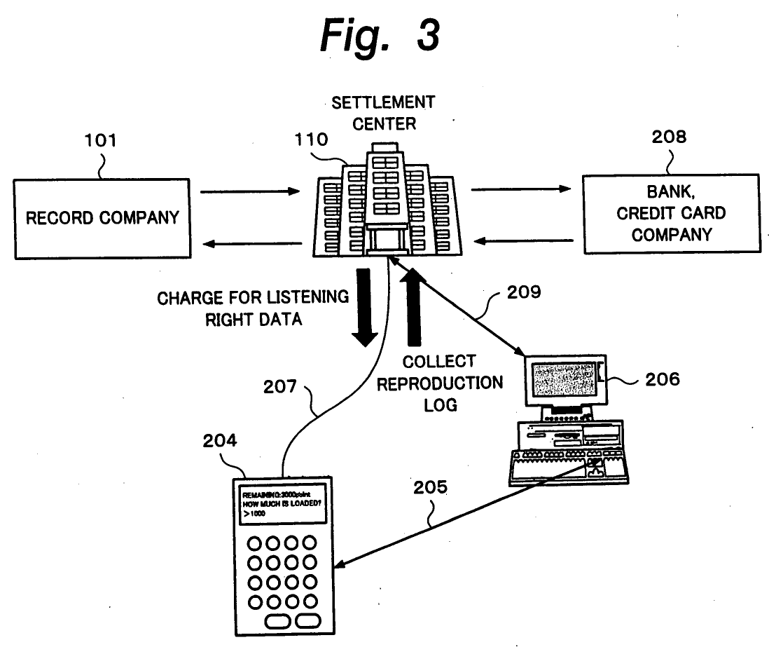

FIG. 3 shows a correlation among the record company 101, settlement center 110, listening right data charger 204, and listening right data sales terminal 206, and bank/credit card company 208 in the charge processing system shown in FIG. 2. Between the charger 204 and sales terminal 206, the settlement center 110 has functions for selling the listening right data, collecting the reproduction logs, and performs a settlement of the costs on the basis of the listening right data.

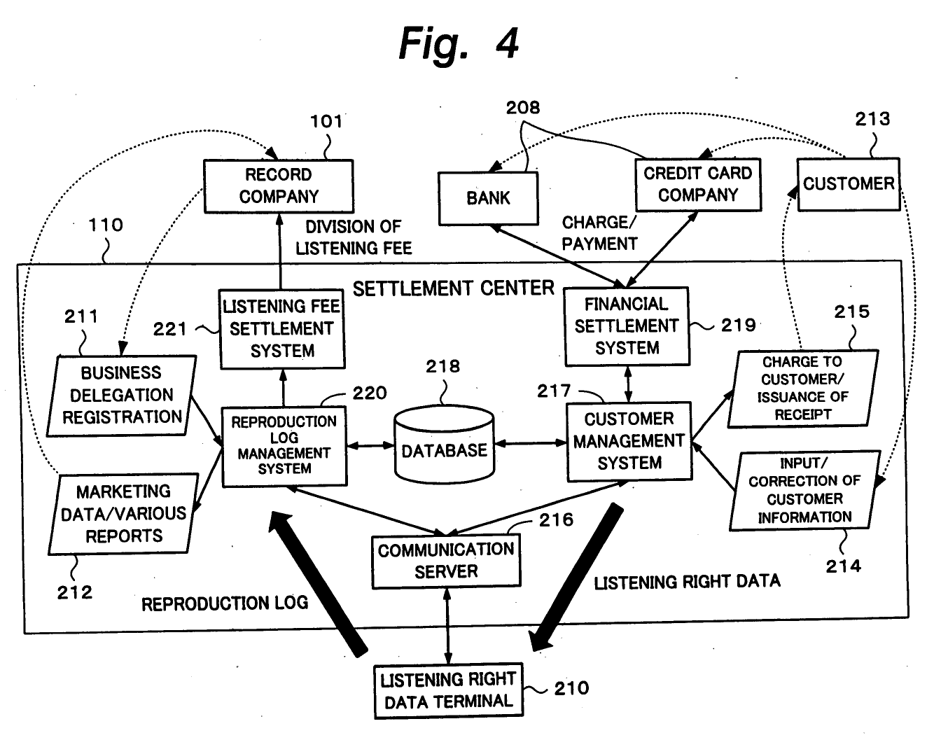

The invention is applied to the settlement center 110 or sales terminal 206. FIG. 4 shows the functions of the settlement center 110 connected to a listening right data terminal 210 (listening right data charger 204 or sales terminal 206) in more detail. In FIG. 4, a path shown by a solid line denotes processes which are necessary when the charging process is executed. A path shown by a broken line denotes processes which are necessary as a preparation for performing the charging process. In many cases, the processes by the path of the broken line is performed by mail (transmission and reception of document) and the processes by the path of the solid line is performed by data communication.

First, the processes by the path of the broken line will be described. Between the record company 101 and settlement center 110, the record company 101 performs a business delegation registration to the settlement center 110 (block 211). The settlement center 110 hands marketing data to the record company 110 and issues various reports (block 212).

A customer 213 as an owner of the listening right data charger 204 makes a contract such as payment of the fee, withdrawal of the fee from the account, and the like with the bank/credit card company 208. The customer 213 reports a change of the contracted contents or the like to the settlement center 110 and the settlement center 110 inputs and corrects customer information (block 214). The settlement center 110 issues and sends a bill and a receipt by mail (block 215).

The processes by the path of the solid line will now be described. The settlement center 110 sends the listening right data to the listening right data terminal 210 in response to a request of the customer. In this case, the customer is specified and the data including the listening right data which was authenticated and encrypted is sent through a communicating server 216. A customer management system 217 specifies the authenticated customer with reference to the customer information in a database 218. On the basis of an amount of transferred listening right data, the system 217 requests a financial settlement system 219 to withdraw the fee. The financial settlement system 219 requests the bank/credit card company 208 to pay the fee from the account of the customer, so that the payment of the fee is executed. When the settlement center 110 receives a report indicative of the completion of the payment, the receipt is issued to the customer.

Prior to transferring the listening right data from the settlement center 210, the authentication of the terminal 210 is performed for the listening right data terminal 210. The settlement center 110 receives the reproduction log from the listening right data terminal 210 through the communication server 216. The encryption of the reproduction log received from the terminal 210 is decoded by the communication server 216, and the decoded reproduction log is sent to a reproduction log management system 220. The reproduction log includes: a terminal identifier for specifying the customer (listening right data terminal 210); an identifier for specifying the decoded and reproduced music contents; and data indicative of the number of times of listening of each music contents, a time, and a period. The terminal identifier is used mainly for transferring the listening right data as mentioned above and for the charging process.

The reproduction log management system 220 temporarily stores the reproduction log into the database 218 and hands the reproduction log or the data obtained by processing the reproduction log to a listening fee settlement system 221 by a batch process at every predetermined time, for example, every month. The listening fee settlement system 221 calculates the listening fee (copyright use fee) of each music piece with reference to the information of the music pieces registered in the database 218 at the time of the business delegation from the record company 101. Besides the music pieces, the listening fee can be also calculated every item such as composer, song writer, singer, player, or the like. The listening fee of each music piece calculated by the listening fee settlement system 221 is paid to the record company 101.

As mentioned above, the settlement center 110 transfers the listening right data to the customer 213 and requests for the listening fee. On the other hand, since the settlement center 110 executes the processes for calculating the listening fee every music piece and distributing it, the record company 101 does not need to perform the operations for executing a customer management, calculating the listening fee, and distributing it. Since the settlement center 110 is an organization independent of the record company 101, it can make contracts for business delegation with a plurality of record companies and the number of kinds of music contents which can be selected by the customer can be increased.

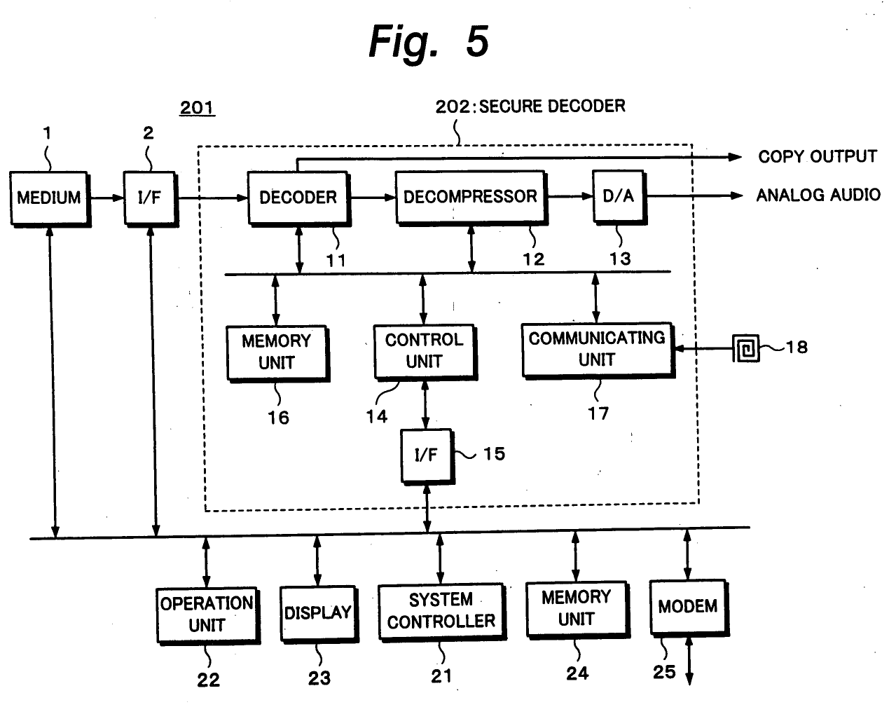

FIG. 5 shows a whole construction of the player 201 having the secure decoder 202. As shown by a broken line, the secure decoder 201 is constructed as an IC of one chip. The secure decoder 201 has a construction of what is called a tamper resistant. That is, it has a construction such that the contents in the decoder 201 cannot be found and falsified from the outside of the secure decoder 201.

The compression encoded and encrypted music data has been recorded in a medium 1. Further, the compression encoded and encrypted data is associated with data necessary for a reproduction charging process. The compression encoded and encrypted data is called contents data and the data for the reproduction charging process is called subordinate data. In the invention, it is not always necessary to perform both of the compression encoding and the encryption. Even if only the compression encoding is used, the object of protection of the copyright of the music data can be accomplished so long as its decoding method is not opened.

As a medium 1, a memory card, a recordable optical disc, a read only optical disc, or the like can be used. In case of the recordable medium, as mentioned above, data including contents data distributed through a network such as satellite network, cellular phone network, Internet, or the like can be downloaded. The contents data and the subordinate data recorded in the medium 1 are supplied to the secure decoder 202 through an interface 2. An analog audio signal is outputted from the secure decoder 202. The analog audio signal is reproduced by speakers, headphones, or the like through an amplifier or the like.

The secure decoder 202 has a decoder 11 of the encryption, a decompressor 12 of the compression encoding, and a D/A converter 13. A DES (Data Encryption Standard) can be used as encryption. The DES is one of block encryptions for dividing a plain sentence into blocks and performing an encryption conversion every block. The DES performs the encryption conversion every block. The DES performs the encryption conversion to an input of 64 bits by using a key of 64 bits (a key of 56 bits and a parity of 8 bits) and outputs 64 bits. An encryption other than the DES can be also used. For example, although the DES is a common key system using the same key data for encryption and decoding, an RSA encryption as an example of public key encryptions using different key data for encryption and decoding can be also used. As mentioned above, the key data is handed to the user device 104 whose authentication has been satisfied.

The secure decoder 202 comprises: a control unit 14 including a CPU; a CPU interface 15 for performing communication between the control unit 14 and an external CPU; a memory unit 16; and a communicating unit 17 and an antenna 18 for receiving listening right data from the data charger 204 and transmitting the reproduction log to the data charger 204 when the listening right data is received. The control unit 14 receives the subordinate data which will be explained later and was separated at the front stage of the decoding in the decoder 11 and performs a control for decoding and decompressing.

The communicating unit 17 and antenna 18 communicate the listening right data with the data charger 204 in a contactless manner. The communication of the data between the secure decoder 202 and charger 204 is executed by using an encrypted protocol under a condition that the player 201 is authenticated. Since not only the listening right data but also an electric power necessary for the operation of the player 201 can be received from the charger 204, even if a power source of the whole player 201 is OFF, the reception of the listening right data and the transmission of the reproduction log can be performed between the player 201 and charger 204. The listening right data received from the charger 204 is stored into the memory unit 16. Further, the reproduction log of the player 201 is also stored into the memory unit 16. The memory unit 16 is a non-volatile memory whose memory contents are held even if the power source of the player 201 is turned off.

A copy output can be outputted from the decoder 11 to the outside of the secure decoder 202. Whether the copy is outputted or not is controlled by the control unit 14. The copy output which is outputted from the secure decoder 202 is the subordinate data and the contents data. Further, the decoder 11 and decompressor 12 have functions for omitting the decoding process and decompressing process on the basis of instructions from the control unit 14, respectively. By making the decoder 11 and decompressor 12 inoperative, the player 201 can reproduce the audio data which is not encrypted and the audio data (linear PCM) which is not compression encoded.

A system controller shown at 21 is provided for controlling the whole operation of the player 201. The system controller 21 is constructed by a CPU and controls the operation of the secure decoder 202 by communicating with the control unit 14 in the secure decoder 202. An operation unit 22, a display 23, a memory unit 24, and a modem 25 are connected to the system controller 21 through a bus. Further, the system controller 21 controls the reproducing operation of the medium 1 and the operation of the medium interface 2.

The operation unit 22 corresponds to a plurality of switches, keys, etc. which are operated by the user and generates an instruction for controlling the operation of the player 201. The system controller 21 controls the operation of each section on the basis of an input from the operation unit 22. The display 23 is constructed by, for example, a liquid crystal device and used for displaying a menu for controlling the operation of the player 201 and displaying an operating mode of the player 201. The memory unit 24 is an external memory provided because a capacity of the memory in the system controller 21 is small. The modem 25 is connected to a public line and used for data communication with the outside. For example, by transferring the reproduction log and the listening right data in the memory unit 16 of the secure decoder 202 to the memory unit 24, the system controller 21 can form data regarding the remaining reproduction possible amount regarding the remaining number of reproduction possible times or the remaining reproduction possible time, display them onto the display 23, and transmit the reproduction log through the modem 25. Further, the listening right data can be also received through the modem 25. As mentioned above, the player itself also has the functions of the data charger.

When the user operates the operation unit 22, the system controller 21 instructs the control unit 14 to reproduce desired contents data in the medium 1. If the contents data to be reproduced is the data which is free with respect to the reproduction, even if an analog output is generated by passing through the secure decoder 202, the listening right data stored in the memory unit 16 is not changed. If the reproduced contents is the contents as a target of the reproduction charge, the listening right data in the memory unit 16 is changed. For example, as mentioned above, the reproduction possible degree as listening right data is subtracted by “1”.

Various types are possible as a charging process. The charging process is mainly classified into: a buying type; a type of grossly charging a monitoring fee; and a degree type of charging a monitoring fee each time the encryption of the contents data is decoded by the secure decoder 202. The buying type is a type such that after the contents data is once bought, the reproducing process of the contents data is not charged for. The type of grossly charging the monitoring fee is classified into a type of a monthly contract such that the monitoring fees caused due to the reproduction of the contents data are collectively paid, a type such that a monitoring period and a monitoring time are limited, and the like.

Several forms are possible as a degree type of charging the monitoring fee each time the encryption of the contents data is decoded by the secure decoder 202. According to the first form, each time the reproducing process of the contents data is executed, a money amount or a degree is subtracted from a preset money amount (prepaid card, electronic money) or a degree. In the case of the first form, if a balance or a remaining degree lacks, the contents data cannot be reproduced. According to the second form, a money amount or a degree is added each time the reproducing process of the contents data is executed. In case of the second form, when the accumulated money amount or accumulated degree reaches the money amount or degree which has been preset, the contents data cannot be reproduced. According to the third form, the degree or money amount is added or subtracted in accordance with the reproducing time of the contents data.

The money amount or degree which is added or subtracted can be made constant or can be also weighted in accordance with the kind or the like of the contents data to be reproduced. The charging process is performed in correspondence to one title of the contents data (in an example of music; one music piece) or a plurality of titles of the contents data (in an example of music; album).

As a method of defining the reproducing process of the contents, in the case where the whole contents or contents data has been reproduced, it can be defined such that the contents or contents data was reproduced. In the case where the reproducing time of the contents or contents data is equal to or longer than a predetermined time, it can be also defined such that the contents was reproduced. Further, the reproduction of the contents for promotion for promoting spread and circulation is not charged. Even in case of contents serving as a target of charging, for example, the reproduction of a head portion of the contents, for instance, 10 seconds from the head of the contents data can be made free or the reproduction of the contents data of only the highlight portion of the contents can be made free. As mentioned above, in the case where the contents whose reproducing process is charged for and the contents whose reproducing process is free exist mixedly, the charge/free is discriminated by the subordinate data added to the contents data.

The subordinate data is the data added before the contents data (compression encoded and encrypted contents; for example, audio data). The subordinate data is encrypted as necessary. The subordinate data is added before the contents data and recorded onto a recordable medium or recorded into an area for data management on the medium 1. In case of a read only medium, as subordinate data, subordinate information is recorded into the data management area. In case of an optical disc, generally the management area is provided in an area on the innermost rim side of the disc. In case of the memory card, for example, file management data such that one music piece of the music data is handled as one file is specified.

The subordinate data includes: a charge identifier for instructing whether the contents is contents to be charged for or free contents; and a reproducing conditions label for distinguishing the charge type such as buying type, gross type, degree type, or the like as mentioned above and instructing the charge conditions in each charge type. For example, when the reproducing conditions label indicates the buying type, the data of the buying price is described on the reproducing conditions label. In case of limiting the number of reproducing times of the gross type, the data of the number of reproducing times is described on the reproducing conditions label. In case of limiting the reproducing period of the gross type, the data (1 day, 1 week, 1 month, etc.) of the reproducing period is described as a reproducing conditions label. In case of the degree type, data of the degree (¥1/2 minutes, ¥1/1 minute, ¥1/30 seconds, . . . ) is described as a reproducing conditions label. Further, even in case of the contents which is charged for as a prerequisite, the conditions in the case where the contents data can be monitored free of charge can be also described on the reproducing conditions label.

Information indicative of the kind of compression encoding of the contents data, information indicative of the kind of encryption and parameters of the encryption, information indicative of the number of channels, information indicative of a bit rate, and the like can be also recorded in the subordinate data.

Further, a media ID, for example, a serial number for enabling the media such as CD, MD, recordable optical disc, memory card including a non-volatile memory, and the like to be unconditionally identified is included in the subordinate data. Moreover, a decoder ID is arranged in the subordinate data. The decoder ID is an ID, for example, a serial number for enabling a user's terminal and the secure decoder 202 built in the player 201 or the like of the user to be unconditionally identified.

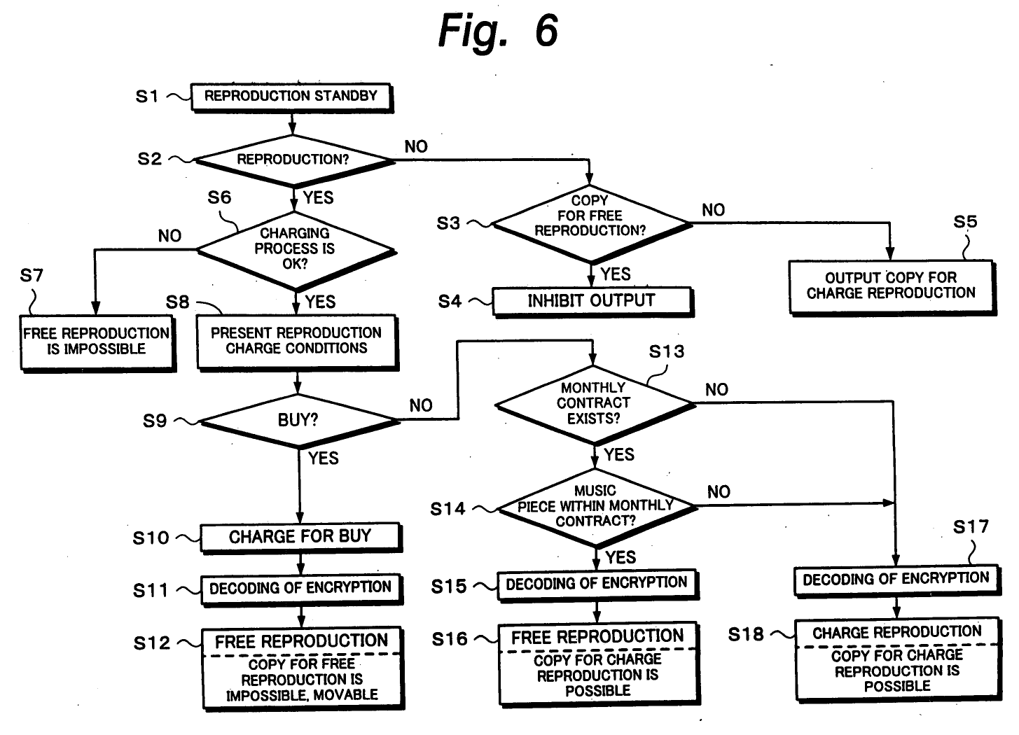

An example of the charging process which is executed in the player 201 shown in FIG. 5 will now be described with reference to a flowchart of FIG. 6. The charging process is executed by the control unit 14 in the secure decoder 202 and the system controller 21. First step S1 indicates a reproduction standby mode in which the contents data to be reproduced exists in the medium 1. Specifically speaking, a case where the contents data distributed by the EMD mentioned above has been stored in the medium 1, a case where the contents data has already been recorded in the medium 1, or the like corresponds to the reproduction standby mode. In step S2, the user depresses a play button of the operation unit 22, so that whether the reproduction has been instructed or not is discriminated.

If a result in step S2 indicates NO, this means the copying operation instead of the reproduction of the contents data. In step S3, whether the contents for free reproduction is copied or not is discriminated. The contents for free reproduction denotes the contents which is not charged for due to the reproduction. The discrimination in step S3 is made with reference to the identifier included in the subordinate data. If it is determined in step S3 that the contents is the contents for free reproduction, the copy output from the secure decoder 202 in which the encryption has been decoded is inhibited for the purpose of protection of the copyright (step S4).

If it is determined in step S3 that the contents is not the contents for free reproduction, that is, if it is decided that the contents for charge reproduction is copied, the copy of the contents for charge reproduction is outputted from the secure decoder 202 (step S5). The contents for charge reproduction is freely copied. This copy output, however, is the subordinate data and the encrypted and compression encoded data.

If it is decided in step S2 that the play button has been operated and the reproducing operation has been instructed, whether the charging process is permitted or not is discriminated in step S6. For example, a message is displayed onto the display 23 of the player 201, thereby promoting the user so as to answer by the operation of the operation unit 22. If the user does not permit the charging process, the free reproduction cannot be performed (step S7). There is also a case where a situation such that the partial free reproduction which is instructed by the reproducing conditions label of the contents data selected so that the user intends to reproduce it, for example, the reproduction of the head portion or highlight portion of the contents data of the music piece is executed free of charge is permitted. If the user permits the charging process, the reproduction charge conditions regarding the contents to be reproduced at present are presented on the display 23 in step S8. The charge conditions are presented on the display 23 on the basis of the information of the reproducing conditions label in the subordinate data.

In step S9, whether the charge type is the buying type or not is discriminated. If it is the buying type, the charge for buying is performed (step S1). Instep S11, the encryption performed to the contents data is decoded in the decoder 11 of the secure decoder 202 by using the key. In step S12, the free reproduction of the contents data is performed. In this case, the copy of the contents to be reproduced free of charge is inhibited. If the movement, that is, the moving process of the contents such that unlike the copy, the contents does not remain in a storing unit or memory medium in which the original data becomes a copy source is possible.

If it is determined in step S9 that the charge type is not the buying type, whether the charge type is the gross type, for example, the monthly contract type or not is determined in step S13. When the monthly contract exists, whether the contents is the contracted music piece or not is discriminated in step S14. If it is decided in step S14 that the contents is the contracted music piece, that is, the contents data, step S15 follows and the free reproduction of the contents data is performed. In this case, the contents for charge reproduction can be freely copied.

If it is decided in step S13 that the charge type is not the monthly contract type, it is determined that the contents data to be reproduced is the degree type and charged for. In step S17, the encryption performed to the contents data is decoded. Instep S18, the charge reproducing process is performed. In the charge reproduction, as mentioned above, the reproduction is charged for in accordance with the degree of reproduction, reproducing time, and the like. The contents for charge reproduction can be freely copied in step S18. Further, even if it is determined in step S14 that the contract is not a range of the monthly contract, the charge reproducing process (step S17, step S18) is performed.

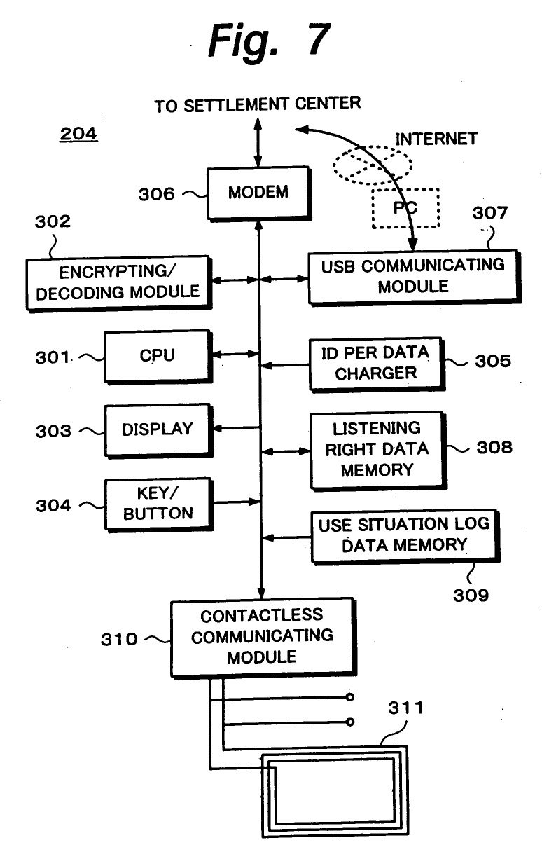

FIG. 7 shows a construction of an example of the data charger 204. The charger 204 has a construction of, for example, a portable type in which it can be carried. Reference numeral 301 denotes a CPU for controlling the whole charger; 302 an encrypting/decoding module; 303 a display (for example, liquid crystal display device); and 304 a key/button which is operated by the user. A menu, charge processing conditions, and the like regarding the operation of the charger 204 are displayed on the display 303. The encrypting/decoding module 302 executes the encrypting process upon transmission and the decoding process of the encryption upon reception. Reference numeral 305 denotes a storing unit in which an ID per data charger has been stored. The ID per data charger stored in the storing unit 305 is transmitted to the settlement center, for example, together with the reproduction log, thereby enabling a correspondence relation between the data charger 204 and the reproduction log to be known.

A modem 306 and a USB (Universal Serial Bus) communicating module 307 are provided for communication with the settlement center (settlement center 110 in FIG. 2). Communication with the settlement center is performed by the modem 306 through a telephone line, the listening right data can be received from the settlement center, and the reproduction log can be transmitted from the data charger 204 to the settlement center. Communication with the settlement center can be also similarly performed by the personal computer and Internet by using the USB communicating module 307.

The listening right data received from the settlement center by the data charger 204 is stored into a listening right data memory 308. The reproduction log received from the secure decoder 202 of the player 201 is stored into a use situation memory 309. Log data obtained by adding the log of the charger 204 to the reproduction log is transmitted to the settlement center as necessary. The memories 308 and 309 are non-volatile memories such that the memory contents in the memories 308 and 309 are held even if the power source of the charger 204 is turned off.

A contactless communicating module 310 and an antenna 311 are used for communicating data such as a reproduction log or the like with the player 201 in a contactless manner. This communication is performed by using an encrypted protocol under a condition that the authentication is performed between the player 201 and charger 204. The charger 204 can transmit an electric power necessary for making the player 201 as well as the secure decoder 202 operative to the player 201 through the module 301 and antenna 311 without limiting to the communication of the data such as a reproduction log or the like. Therefore, even if the main power source of the player 201 is OFF, the listening right data and the reproduction log can be transmitted and received between the secure decoder 202 and charger 204. Besides the antenna 311, a terminal for line connection is also provided. Communication with the listening right data sales terminal 206 is performed by using lines connected to the contactless communicating module 310 and antenna 311 or the terminal for line connection.

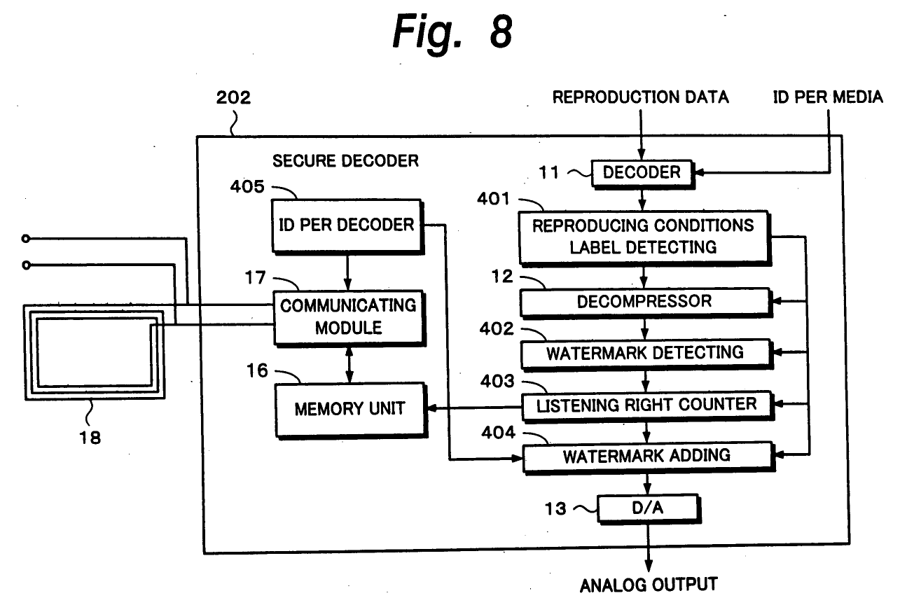

FIG. 8 shows a more detailed construction of the secure decoder 202, that is, a functional construction regarding the charging process. Portions corresponding to the component elements shown in FIG. 7 are designated by the same reference numerals. The data comprising the encrypted and compression encoded contents data and subordinate data read out from the medium 1 is supplied to the decoder 11. The ID per media for enabling the medium 1 to be unconditionally identified is also supplied to the decoder 11. The encryption performed to the data read out by the medium 1 is decoded by the decoder 11.

The output data of the decoder 11 is supplied to a reproducing conditions label detecting unit 401 and the reproducing conditions label in the subordinate data is decoded and outputted. The reproducing conditions label outputted from the decoder 11 is used for the process of the secure decoder 202. In the decompressor 12, a decompressing process of the compression encoding is performed to the output data from the decoder 11 supplied through the label detecting unit 401. The output data of the decompressor 12 is supplied to a watermark detecting unit 402. The watermark detecting unit 402 detects the watermark added upon analog output and discriminates whether the reproducing conditions label has been falsified or not on the basis of the detected watermark and the reproducing conditions label.

Reference numeral 403 denotes a listening right counter. In the listening right counter 403, as will be explained in more detail herein later, each time the data read out from the medium 1 is decoded, the listening right data is changed. For example, the counter 403 executes a process for subtracting the listening right data, for example, degree data stored in the memory unit 16. The listening right data stored in the memory unit 16 is the data transmitted from the foregoing data charger 204 by the antenna 18 (or line) and communicating module 17. Encrypting and decoding modules are provided in the communicating module 17. Although a terminology “listening right” is used here to handle the music piece data, when considering also including video data, a terminology “monitoring right” is used in place of “listening right”.

When the process regarding the listening right is performed in the listening right counter 403, a watermark is added to the output data by a watermark adding unit 404. As for the watermark which is added to the data by the adding unit 404, the watermark can be added by using a redundant portion existing in the music piece data, for example, by using lower bits of audio data which is outputted. The added watermark is data which remains even if the data is converted into the analog signal and it is impossible or fairly difficult to remove the watermark. The watermark which is added by the adding unit 404 includes data of the whole or a part of the reproducing conditions label and information of an ID 405 per decoder. The data to which the watermark has been added is converted into the analog signal by the D/A converter 13 and outputted to the outside of the secure decoder 202. The foregoing watermark detecting unit 402 detects the watermark added as mentioned above.

It is also possible to construct the apparatus in a manner such that the secure decoder 202 has an interface of an IC card and the data charger 204 receives electronic money from the settlement center or a financial company and records the received electronic money into the IC card through the interface which the secure decoder 202 has. That is, the secure decoder 202 can be allowed to have a function as a recording apparatus of the electronic money as an optional device in response to the writing of the listening right data.

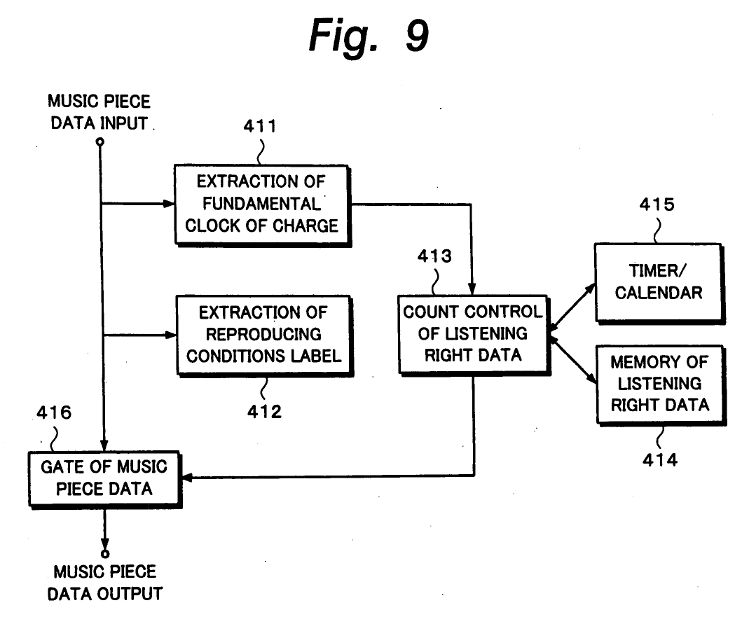

FIG. 9 shows the portion of the listening right counter 403 in more detail. An example in which the invention is applied to a case where the charging process is performed by the degree type will now be described. That is, the degree is subtracted from a preset degree each time the reproducing process of the contents data as music piece data is executed, the degree is added each time the reproducing process of the contents data as music piece data is executed, or the degree is added or subtracted in accordance with the reproducing time of contents data as music piece data.

A reproducing conditions label extracting unit 411 extracts the reproducing conditions label from the data read out from the medium 1, for example, from the music piece data. The charge conditions are included in the reproducing conditions label extracted by the extracting unit 411. Fundamental clocks of the charge are extracted by a fundamental clock extracting unit 412 from the contents data as music piece data. The extracted fundamental clocks are generated only for a period of time during which the music piece data is outputted from the decompressor 12. A period of the fundamental clocks is fixed every contents data as music piece data and they are generated at a period of 2 minutes, 1 minute, 30 seconds, or the like. A plurality of fundamental clocks can be also made to correspond to those periods. The period of the fundamental clocks is handled as a unit of charge. That is, one period of the fundamental clocks is made to correspond to one degree and is made to correspond to a unit of the time.

On the basis of the extracted fundamental clocks and reproducing conditions label, a count control unit 413 of the listening right data controls the counting operation. That is, the subtracting or adding process is performed to the listening right data stored in a memory 414 (a part of the memory unit 16) of the listening right data with reference to the reproducing conditions label, thereby rewriting the listening right data in the memory 414. If the reproducing time or reproducing period is set to the reproducing conditions label, an accumulating process of the reproducing time or a collating process for collating the present date and time with the reproduction possible term is executed to a timer/calendar.

The listening right data count control unit 413 further discriminates whether the contents data can be reproduced or not. For example, when the reproduced degree is subtracted and the remainder is equal to “0”, it is determined that the contents data cannot be reproduced. If the accumulated degree reaches a set degree, the accumulation of the reproducing time reaches a set time, or the present date and time expires the reproducing term, it is also similarly determined that the contents data cannot be reproduced. On the basis of a discrimination result, a gate portion 416 of the music piece data is controlled. If the contents data can be reproduced, the music piece data passes through the gate portion 416 and is outputted. On the other hand, if the contents data cannot be reproduced, the output of the music piece data is inhibited by the gate portion 416. If it is determined by the control unit 413 that the further reproduction of the contents data is impossible, a message indicating that the contents data cannot be reproduced any more can be also displayed onto the display 23 of the player 201.

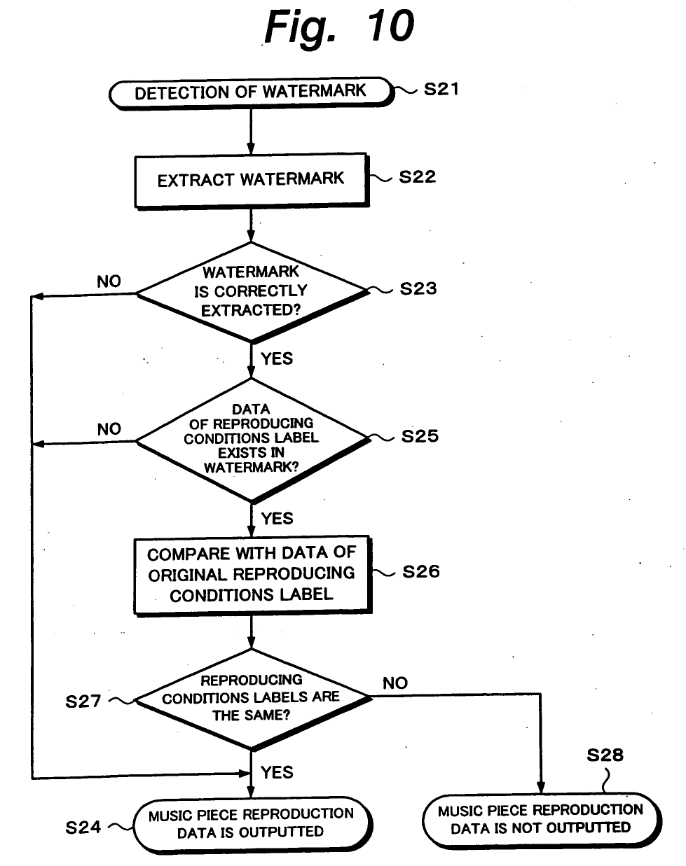

The process of the watermark detecting unit 402 in the secure decoder 202 shown in FIG. 8 will now be described with reference to a flowchart of FIG. 10. When a detecting process S21 of the watermark is started, an extracting process of the watermark is executed in step S22. In step S23, whether the watermark has correctly been extracted in step S22 or not is discriminated.

If it is determined in step S23 that the watermark is not correctly extracted, this means that the watermark is not added, so that the music piece reproduction data is outputted (step S24). If it is decided in step S23 that the watermark has correctly been extracted, whether the data of the reproducing conditions label has been inserted in the watermark or not is discriminated in step S25. If it is decided in step S25 that the reproducing conditions label is not inserted, step S24 follows and the music piece reproduction data is outputted.

If it is decided in step S25 that the date of the reproducing conditions label has been inserted in the watermark, in step S26, a collating process of the reproducing conditions label in the watermark and the reproducing conditions label in the subordinate data detected by the reproducing conditions label detecting unit 401 is performed. In step S27, whether those reproducing conditions labels coincide or not is discriminated. If it is determined in step S27 that those two reproducing conditions labels are the same, the music piece reproduction data is outputted (step S24). If it is determined in step S27 that those two reproducing conditions labels are not equal, it is decided that there is a possibility that at least one of the reproducing conditions labels has been falsified, so that the music piece reproduction data is not outputted (step S28).

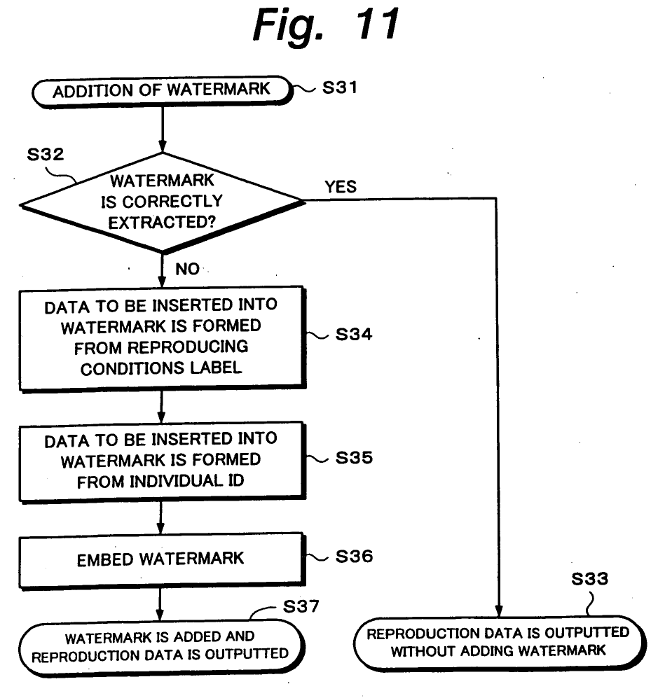

FIG. 11 is a flowchart showing the watermark adding process which is executed by the watermark adding unit 404 of the secure decoder 202. When the watermark adding process S31 is started, in step S32, whether the watermark detecting unit 402 could correctly extracted the watermark or not is discriminated. In step S32, if it is determined that the watermark could correctly been extracted on the basis of step S27 mentioned above, the watermark is not added and the reproduction data is outputted (step S33). That is, the watermark embedded in the data read out from the medium 1 is not changed.

If the result in step S32 is NO, data which is inserted into the watermark is formed in steps S34 and S35. Step S34 relates to a process for forming the data which is inserted into the watermark from the reproducing conditions label. In step S34, a part or all of the reproducing conditions label is inserted as a watermark. The data which is embedded as a watermark formed in step S34 is not limited to the data itself of the reproducing conditions label but can be data such as a hash value or the like which was arithmetically operation processed. Step S35 relates to a process for forming the data to be inserted into the watermark from the individual ID data of the secure decoder. In step S35, a part or all of the ID data per secure decoder is inserted into the watermark. By inserting the individual ID data, the secure decoder 202 to which the watermark has been added can be specified.

In step S36, the watermark comprising the data formed in steps S34 and S35 as mentioned above is embedded into the music piece data which is outputted from the secure decoder 202. As mentioned above, the watermark is embedded by using the redundant portion of the music piece data. Although the watermark is digitally added, it remains even if the music piece data is converted into the analog signal and it is impossible or very difficult to remove the watermark. In step S37, the watermark is added and the reproduction data is outputted.

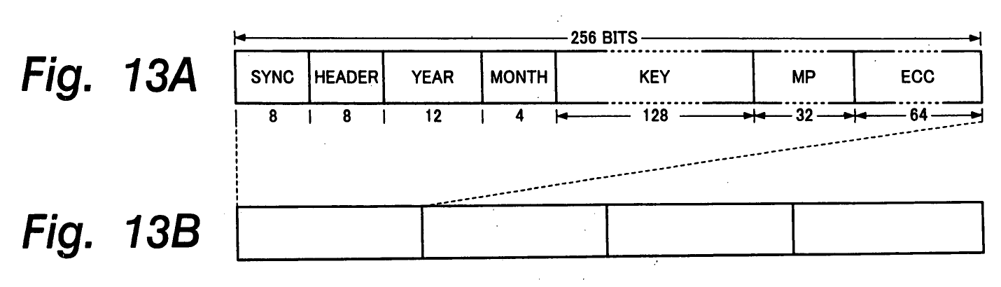

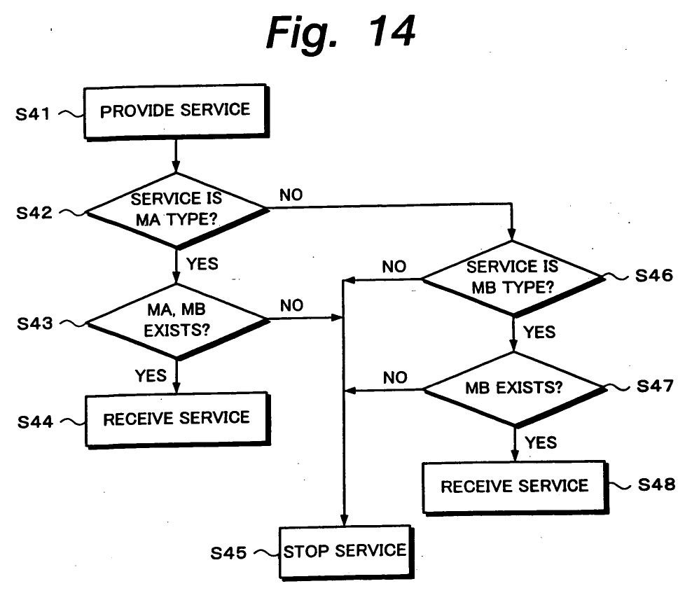

With respect to the listening right data which is handed from the settlement center 110 or listening right data sales terminal 206 to the data charger 204 mentioned above and the listening right data which is handed from the data charger 204 to the player 201, a case of limiting the use period of the listening right data will now be described by using FIG. 13 and subsequent drawings.

FIGS. 13A and 13B show an example of a format at the time when the listening right data is handed to the data charger 204. FIG. 13A shows a construction of one frame (256 bits). A sync signal (8 bits) is located at the head of the frame. A header (8 bits) is located after that. The presence or absence of the limitation of the use period of the listening right data is shown by the header. For example, the header of 8 bits all of which are equal to 0 (00000000) indicates the absence of the limitation of the period of the listening right data. The header (0001xxxx) indicates the presence of the limitation of the period of the listening right data. Lower 4 bits (xxxx) denotes “undefined”. However, the listening right data by which only the old songs can be freely listened to and the listening right data by which songs including the new songs can be freely listened to can be distinguished by using lower 4 bits.

Subsequently, the year of the use period of the listening right data is expressed by 12 bits and the month (January to December) of the use period of the listening right data is expressed by 4 bits. Assuming that the year is equal to A.D. Y, the value of (2000−Y) is expressed by 12 bits. The use period of the listening right data is also expressed by the year and month. When the use period of the listening right data is the data of, for example, July 2000, the contents data, for example, the music piece data can be listened to for a period of time between Jul. 1, 2000, to Jul. 31, 2000. As mentioned above, the music piece data can be freely listened to for the period of time between Jul. 1, 2000, to Jul. 31, 2000. In this case, the degree (point) of the listening right data is not subtracted. The data of the use period of the listening right data has been encrypted.

The portion of 128 bits subsequent to the portion showing the month of the use period of the listening right data indicates a key for decoding the encryption. Specifically speaking, it is a key for decoding the encryption of the data of the use period of the listening right data and for decoding the encryption for encrypted listening right data MP (if use possible period is limited, its listening right data). The DES, RSA, or the like can be used as means for encryption. The DES is one of block encryption for dividing a plane sentence into blocks and performing an encryption conversion every block. The DES performs an encryption conversion by using a key of 64 bits (a key of 56 bits and a parity of 8 bits) to an input of 64 bits and outputs 64 bits. The DES is a common key system using the same key data for encryption and decoding. The RSA is one of the public key encryptions using different key data for encryption and decoding. The other encryption can be also used.

After the encryption key, the encrypted listening right data MP of 32 bits is arranged. The data MP can express values up to 232. After the data MP, an ECC (Error Correction Code) of 64 bits is arranged, so that a data array of one frame is completed. For example, a Reed-Solomon code is used as an ECC.

To raise an error resistance of the listening right data, the same data is repetitively transmitted four times as shown in FIG. 13B. The numerical value of 4 times is an example and the proper number of repetition times is set in accordance with an error rate. When the listening right data is repeated four times, the data is separated by (256×4=1024 bits).

To decode the encryption of the data of the use period of the listening right data and the listening right data MP, the comparison collation and the error correction by the ECC are executed, a key for decoding is obtained, and the listening right data MP can be subsequently decoded by the key for decoding. It is also possible to add an EDC (Error Detection Code) to the listening right data and perform the error detection. Further, it is also possible to scramble (for example, random conversion using the maximum duration period (M) series) to the whole data shown in FIG. 13A as necessary.

Since the invention fundamentally relates to the system in which the electronic money and electronic use right having the period limitation and the electronic money and electronic use right having no period limitation exist mixedly, two or more slots of the format shown in FIG. 13B are prepared.

According to the transmission format of the listening right data shown in FIGS. 13A and 13B, the important portion consists of only 32 bits of the listening right data MP. However, such an important portion is protected by the encryption and the ECC (falsification can be checked). Thus, a situation such that the listening right data is illegally obtained or falsified can be prevented.

FIG. 14 is a flowchart showing an embodiment of providing services. A type of the listening right data having no limitation of the use period is assumed to be MA and a type of the listening right data having the limitation of the use period is assumed to be MB. The type MB having the limitation of the use period can be cheaply purchased as compared with the type MA having no limitation of the use period. Services which the user can receive are made different in accordance with the type of the listening right data. In step S41 in FIG. 14, when the providing of the services is started, whether the provided services relate to the type MA of the listening right data or not is discriminated in step S42.

If it is determined that the provided services relate to the type MA, the presence or absence of the listening right data (MA or MB) which the user possesses is discriminated in step S43. If there is the listening right data of one of those types in step S43, the provided services are received, for example, the reproduction of the contents data can be performed (step S44).

If a result in step S42 is NO (that is, the provided services do not relate to the type MA of the listening right data), whether the services relate to the type MB of the listening right data or not is discriminated in step S46. In case of the services corresponding to the type MB, the presence or absence of the type MB of the listening right data is discriminated in step S47. If there is the type MB of the listening right data, the services are received, for example, the contents data can be reproduced in step S48. If a discrimination result in step S46 or S47 is NO, since the services cannot be received, the providing of the services is stopped, for example, the contents data cannot be reproduced.

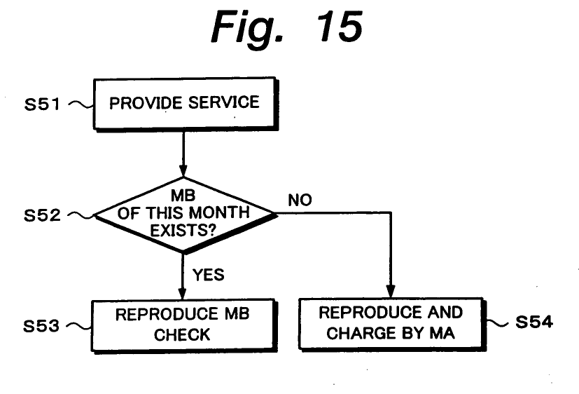

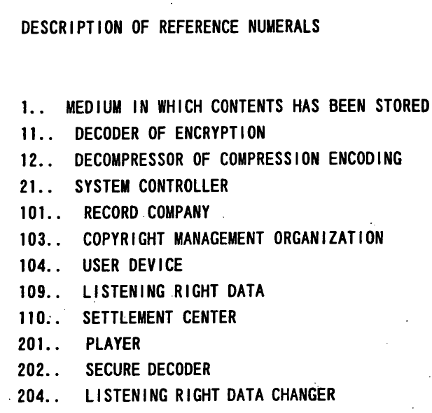

In case of the listening right data having the period limitation, the contents data can be used for such a period of time without any restriction. For example, the audio contents data can be reproduced and listened to without limitation. A flowchart of FIG. 15 shows such a process.

In step S51 in FIG. 15, when the providing of the services is started, for example, when the user intends to reproduce the contents data, the presence or absence of the listening right data of the type MB (having the period limitation) of the present month is discriminated in step S52. If there is the listening right data of the type MB of the present month, the provided services can be received, for example, the contents data can be reproduced (step S13). In step S13, the listening right data is checked. This is because even in case of the listening right data of one month, the services which can be received, for example, the services such that the contents data can be reproduced without any restriction for such a period of time and the like are different in dependence on its price. If it is determined in step S52 that there is not the listening right data of the type MB of the present month, the reproduction charge is performed by the listening right data of the type MA (step S54). In step S54, the presence or absence of the listening right data of the type MA is discriminated.

Although the embodiment has been described mainly with respect to the audio contents, the invention can be also similarly applied to contents such as video data, still image data, character data, computer graphic data, game software, computer program, and the like other than the audio data in a manner similar to that mentioned above.

1-86. (canceled)

87. A communication method between a server, a portable player and a terminal apparatus configured to communicate with said server and said portable player, the method comprising the steps of:
reproducing media data stored in a storage medium in said portable player;
storing a reproduction history for reproduced medium data as a reproduction log in said portable player;
transferring the reproduction log from said portable player to said terminal apparatus;
transferring the reproduction log from said terminal apparatus to said server; and
calculating a royalty for the reproduced media data based on the reproduction log.

88. A server comprising:
a collecting unit configured to collect a reproduction log from a portable player, the reproduction log including a reproduction history for reproduced media data reproduced in said portable player; and
a calculating unit configured to calculate a reotyalty for the reproduced media data based on the reproduction log.

89. The server according to claim 88, wherein the reproduction log is encrypted and further comprising:
a decoder configured to decode the encrypted reproduction log and output the decoded reproduction log, wherein
said calculating unit calculates a royalty for the reproduced media data based on the reproduction log outputted from said decoder.

90. The server according to claim 88, wherein said collecting unit collects the reproduction log through a terminal apparatus.

91. The server according to claim 88, wherein the reproduction log includes information related to at least a reproduction time.

92. A portable player comprising:
a reproduction unit configured to reproduce media data stored in a storage medium;
a storing unit configured to store a reproduction history for media data as a reproduction log;
an encryption unit configured to encrypt the reproduction log stored in said storing unit and to output an encrypted reproduction log, and
an uploading unit configured to upload the encrypted reproduction log outputted from said encryption unit to a server.

93. The portable player according to claim 92, wherein said uploading unit uploads the encrypted reproduction log to said server through a terminal apparatus.

94. The portable player according to claim 92, wherein the reproduction log includes information related to at least a reproduction time.
